(19) United States
(12) Patent Application Publication
(10) Pub. No.: US 2013/0043175 A1
(43) Pub. Date: Feb. 21, 2013

(54) DEVICE FOR ATTACHING UNDILUTED-LIQUID SUPPLY PLATE TO FILTER CLOTH OF FILTER PRESS, AND FILTER PRESS EQUIPPED WITH SAME

(71) Applicants: Koji Hara, Sakaide-shi (JP); Nobuo Honda, Marugame-shi (JP); Kazuhisa Otani, Marugame-shi (JP); Nobuhiro Mineo, Takamatsu-shi (JP); Shoji Motoya, Sakaide-shi (JP); Daisuke Yamamoto, Takamatsu-shi (JP)

(72) Inventors: Koji Hara, Sakaide-shi (JP); Nobuo Honda, Marugame-shi (JP); Kazuhisa Otani, Marugame-shi (JP); Nobuhiro Mineo, Takamatsu-shi (JP); Shoji Motoya, Sakaide-shi (JP); Daisuke Yamamoto, Takamatsu-shi (JP)

(73) Assignee: ISHIGAKI COMPANY LIMITED, Tokyo (JP)

(21) Appl. No.: 13/695,712

(22) PCT Filed: Apr. 25, 2011
(86) PCT No.: PCT/JP2011/060020

§ 371 Date: Nov. 1, 2012

(30) Foreign Application Priority Data
Jun. 10, 2010 (JP) 2010-132710

(51) Int. Cl. B01D 25/176

(52) U.S. Cl. 210/230; 24/453

(57) ABSTRACT

A device for attaching an undiluted-liquid supply plate to a filter cloth includes: a leg to be placed inside a first through hole formed in the filter cloth and inside a second through hole formed in the undiluted-liquid supply plate; a flange provided at an end portion of the leg and having a diameter larger than diameters of the first through hole and the second through hole; and an elastic deformation portion configured to be elastically deformed in a radial direction of the second through hole to allow and restrict movement of the leg placed inside the first and second through holes in an axial direction of the second through hole.

### TECHNICAL FIELD

The present invention relates to a device for attaching an undiluted-liquid supply plate to a filter cloth of a filter press, the plate being configured to supply undiluted liquid to a filter chamber formed between filter plates. The present invention also relates to the filter press equipped with the same.

### BACKGROUND ART

A filter press has a filter cloth hung on filter plates openably and closably arranged in parallel and an undiluted-liquid supply plate fixed to the filter cloth, and is configured to inject undiluted liquid from the undiluted-liquid supply plate into a filter chamber between the filter plates under pressure, and separate the undiluted liquid into solid and liquid using the filter cloth. Patent Literature 1 proposes an example of such a conventional filter press including undiluted-liquid supply plates in which holding plates are fixed with bolts to each of a pair of filter cloths while heads of the corresponding bolts of the respective filter cloths abut on each other, the filter cloths being hung movably in a vertical direction between a filter plate and a compression filter plate. Further, the applicant of the present application proposes in Patent Literature 2 a filter cloth for a filter press in which a liquid supply plate with a fastening member to a pair of filter cloths provided to be vertically movable in a stretched state between filter plates. The applicant of the present application also proposes in Patent Literature 3 a filtration device unit in which filter cloths supported by an upper support bar and each having a weight attached to its lower portion are hung between front and back filter beds of filter plates, and a liquid supply plate is attached to an upper central portion of one of the filter cloths.

### CITATION LIST

### Patent Literature

PLT 1: Japanese Utility Model Application Publication No. Hei 7-5847 (Claims of the utility model registration, Paragraph 0010, and FIGS. 1 and 3)

PLT 2: Japanese Patent Application Publication No. 2007-44641 (Paragraph 0011 and FIGS. 2 and 3)

PLT 3: Japanese Patent No. 3228149 (Paragraphs 0018 and 0023 and FIGS. 4 and 7)

### SUMMARY OF INVENTION

A filter cloth used in a filter press is expendable and therefore requires periodic replacement after repeated filtering operations. Usually, bolts and pins are used to fix an undiluted-liquid supply plate to a filter cloth. However, the bolts and pins have problems that the attachment of such bolts and pins takes time, and that the bolts and pins might fall off due to the loosening of a screw portion or the like. Moreover, if a bolt is loosened, the head of the bolt that sticks out might damage filter plates, diaphragms, gaskets, or filter cloths when filter plates are fastened together. Further, because an undiluted-liquid supply plate tends to cause a clogging phenomenon due to fibers and the like contained in undiluted liquid, the plate needs checkup and cleaning by detaching a filter cloth hung between filter plates and disassembling bolts and pins. Hence, maintenance of the plate is troublesome.

The present invention aims to provide a device for attaching an undiluted-liquid supply plate to a filter cloth of a filter press, which enables easy attachment, detachment, and maintenance with less required time, and a filter press equipped with the same.

The present invention also aims to provide a device for attaching an undiluted-liquid supply plate to a filter cloth of a filter press, which has no possibility of damaging filter plates, diaphragms, gaskets, filter cloths, and the like, and a filter press equipped with the same.

A first aspect of the present invention is a device for attaching an undiluted-liquid supply plate to a filter cloth of a filter press, the plate being configured to supply undiluted liquid to a filter chamber formed between filter plates, the device including: a leg to be placed inside a first through hole formed in the filter cloth and inside a second through hole formed in the undiluted-liquid supply plate; a flange provided at an end portion of the leg and having a diameter larger than diameters of the first through hole and the second through hole; and an elastic deformation portion configured to be elastically deformed in a radial direction of the second through hole to allow and restrict movement of the leg placed inside the first and second through holes in an axial direction of the second through hole.

A second aspect of the present invention is a filter press including: filter plates; a filter cloth placed between the filter plates; an undiluted-liquid supply plate configured to supply undiluted liquid to a filter chamber formed between the filter plates; and the device for attaching an undiluted-liquid supply plate to a filter cloth according to the first aspect.

According to the first and second aspects, the undiluted-liquid supply plate can easily be attached between the pair of filter cloths only by pressing the fastener into the filter cloths. Further, the attachment device never falls off even in the repeated filtering operations, and is easily attached and detached in a short period of time. Furthermore, half-divided undiluted-liquid supply plates can also be employed to prevent a clogging phenomenon due to fibers and the like.

According to embodiments of the present invention, the head flange and the locking claw(s) of the fastener engage with the concave grooves formed in the undiluted-liquid supply plate. Hence, the head flange and the locking claw(s) never stick out and thus have no possibility of damaging fittings such as the filter cloths, filter plates, and gaskets.

According to the embodiments of the present invention, the filter cloths and the undiluted-liquid supply plate are in close contact with one another and thus the loosening of or falling off of the undiluted-liquid supply plate from the filter cloths never occurs. Further, since the concave groove is in the form of an inclined dish-shaped groove, no excessive bending moment is applied to the filter cloths between which the undiluted-liquid supply plate is attached.

According to the embodiments of the present invention, the fastener having the multiple elastic legs suspending from the head flange is used as means for fixing the undiluted-liquid supply plate to the filter cloths. Hence, when the undiluted-liquid supply plate is attached to the filter cloths, the fastener is inserted into each through hole of the undiluted-liquid supply plate from one side of the plate. By doing so, the flexible elastic legs can be compressed and press fitted into the through hole of the undiluted-liquid supply plate, whereby the undiluted-liquid supply plate can be fixed to the filter cloths with the fastener elastically held. This facilitates attachment and detachment of the undiluted-liquid supply plate and also facilitates maintenance. When the locking claw(s) are placed at the tip portion of the fastener and allowed to protrude into the rear surface side of the undiluted-liquid supply plate, the locking claw(s) is (are) locked by the concave groove of the undiluted-liquid supply plate or engage(s) with the fastening member. Thus, the fastener never sticks out and has no possibility of damaging the filter plates, diaphragms, gaskets, filter cloths, and the like. When the fastening member is brought into contact with the concave groove located in the other surface of the undiluted-liquid supply plate, the undiluted-liquid supply plate comes into close contact with the filter cloths, and thus the fastener is never loosened nor allows screen residues or the like to go into a gap. When the concave groove is in the form of an inclined dish-shaped groove, no excessive bending moment is applied to the filter cloths between which the undiluted-liquid supply plate is attached, and durability of the filter cloths is enhanced. If resin is used as a material of the fastener, a highly corrosion-resistant expensive member does not have to be used.

### BRIEF DESCRIPTION OF DRAWINGS

FIG. 1 is a perspective view of a pair of filter cloths to which an undiluted-liquid supply plate used in a filter press according to a first embodiment of the present invention is fixed.

FIG. 2 is a side view of principal part of a filter press in which each undiluted-liquid supply plate is held between the filter cloths and is hung on a filter plate.

FIG. 3 is a plan view of the undiluted-liquid supply plate according to the first embodiment of the present invention.

FIG. 4 is a vertical cross-sectional side view of the undiluted-liquid supply plate of FIG. 3.

FIG. 5 is a side view of a fastener configured to be inserted in each through hole of the undiluted-liquid supply plate of FIG. 3.

FIG. 6 is a vertical cross-sectional side view of a fastening member configured to engage with locking claws of the fastener.

FIG. 7 is a vertical cross-sectional side view of the undiluted-liquid supply plate held between the pair of filter cloths.

FIG. 8 is an enlarged view of principal part of the fastener configured to fix the undiluted-liquid supply plate held between the pair of filter cloths to the filter cloths.

FIG. 9A is a perspective view of a filter press according to a second embodiment, in which filter cloths are hung on front and rear filter plates, respectively.

FIG. 9B is a side view of the filter press of FIG. 9A.

FIG. 10 is a vertical cross-sectional side view of half-divided undiluted-liquid supply plates according to the second embodiment.

FIG. 11 is an enlarged view of principal part of fasteners configured to fix the half-divided undiluted-liquid supply plates of FIG. 10 to the pair of filter cloths respectively and hold them between the filter plates.

FIG. 12A is a side view of a fastener having coupled tip portions of elastic legs according to a third embodiment in an original state.

FIG. 12B is a side view of the fastener having the coupled tip portions of the elastic legs according to the third embodiment in a state where the elastic legs of the fastener are compressed by being press fitted into the through hole of the undiluted-liquid supply plate.

FIG. 13A is a side view of a fastener according to a fourth embodiment, in which an insertion shaft of a male member is inserted in a female member whose elastic legs can be freely expanded and contracted, in an original state where the insertion shaft of the male member is moved backward.

FIG. 13B is a side view of the fastener according to the fourth embodiment, in which the insertion shaft of the male member is inserted in the female member whose elastic legs can be freely expanded and contracted, in a state where the insertion shaft of the male member is moved forward and tip portions of the elastic legs of the female member are expanded.

FIG. 14 is an enlarged view of principal part of a device for attaching an undiluted-liquid supply plate to the filter cloths according to a fifth embodiment.

FIG. 15 is an enlarged view of principal part of a device for attaching an undiluted-liquid supply plate to the filter cloths according to a sixth embodiment.

FIG. 16 is an enlarged view of principal part of a device for attaching an undiluted-liquid supply plate to the filter cloths according to a seventh embodiment.

FIG. 17 is an enlarged view of principal part of a device for attaching an undiluted-liquid supply plate to the filter cloths according to an eighth embodiment.

FIG. 18 is an enlarged view of principal part of a device for attaching an undiluted-liquid supply plate to the filter cloths according to a ninth embodiment.

FIG. 19 is an enlarged view of principal part of a device for attaching an undiluted-liquid supply plate to the filter cloths according to a tenth embodiment.

FIG. 20 is an enlarged view of principal part of a device for attaching an undiluted-liquid supply plate to the filter cloths according to an eleventh embodiment.

FIG. 21 is an enlarged view of principal part of a device for attaching an undiluted-liquid supply plate to the filter cloths according to a twelfth embodiment.

### DESCRIPTION OF EMBODIMENTS

Hereinafter, embodiments of the present invention are described in detail with reference to the drawings.

### First Embodiment

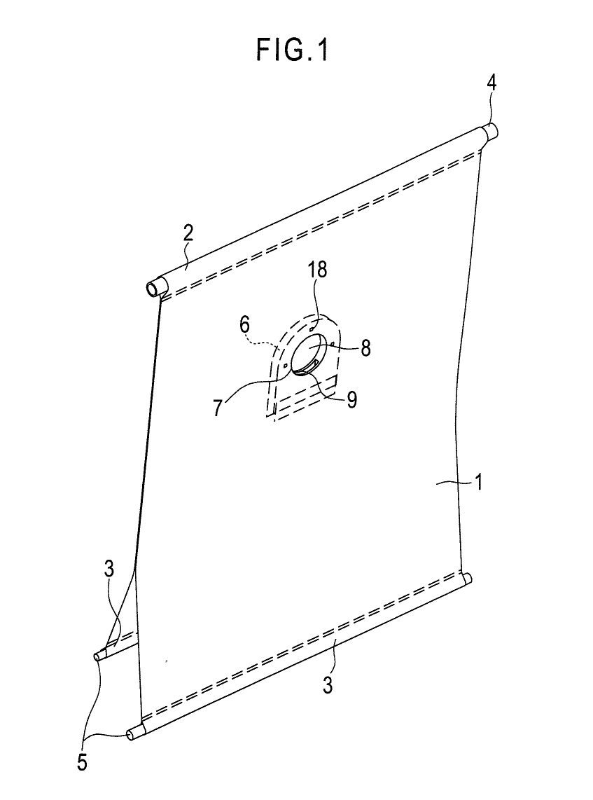

FIG. 1 is a perspective view of a pair of filter cloths 1, 1 to which an undiluted-liquid supply plate 6 is fixed. Upper end edges of the pair of filter cloths 1, 1 are attached together to form a sleeve portion 2. Sleeve portions 3, 3 are formed at lower end edges of the filter cloths 1, 1, respectively. An upper filter cloth core bar 4 is inserted into the upper-end-edge sleeve portion 2 and lower filter cloth core bars 5, 5 are inserted into the lower-end-edge sleeve portions 3, 3, respectively. The undiluted-liquid supply plate 6 is held between the pair of filter cloths 1, 1 while insertion holes 7 opened respectively at upper central portions of the filter cloths 1, 1 communicate with an undiluted-liquid path 8 of the undiluted-liquid supply plate 6. The undiluted-liquid supply plate 6 includes a liquid supply path 9 branching from the undiluted-liquid path 8 and configured to supply undiluted liquid to filter surfaces of the respective filter cloths 1, 1.

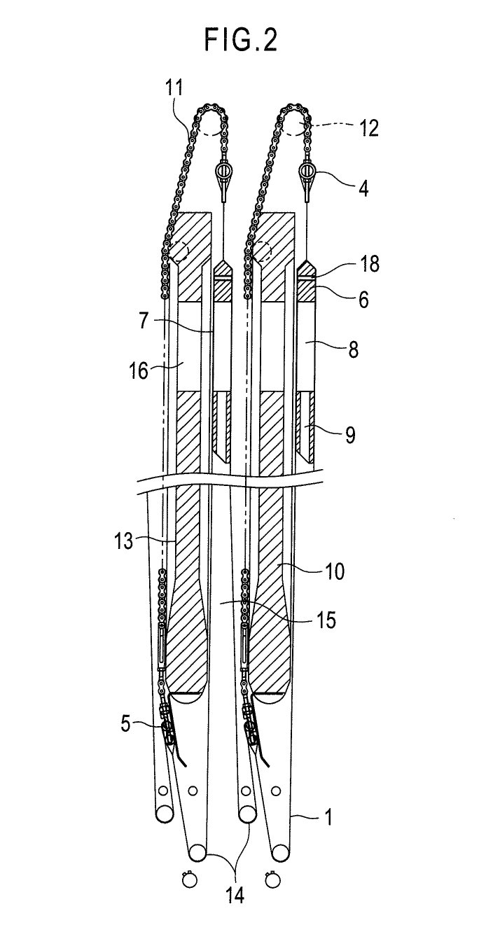

FIG. 2 is a side view of principal part of a filter cloth-moving type filter press in which each undiluted-liquid supply plate 6 is held between the pair of filter cloths 1, 1 and is hung on a filter plate 10. The pair of filter cloths 1, 1 shown in FIG. 1 are placed between filter plates 10 . . . openably and closably arranged in parallel. Driving chains 11, 11 are respectively connected to two ends of the upper filter cloth core bars 4 of the filter cloth 1, and wound around sprockets 12, 12 hung on and supported by shoulder portions of the filter plates 10. Lower end portions of the pairs of filter cloths 1, 1 which are hung at positions in front of and behind the filter plates 10 are respectively wound around return rolls 14, 14 which suspend vertically from lower portions of the filter plates 10 in positions displaced from the lower portions. Two ends of each of the lower filter cloth core bars 5, 5, which are inserted in lower ends of the pairs of filter cloths 1, 1, are connected to the other ends of the driving chains 11, 11, respectively, whereby the filter cloths 1 . . . can be moved up and down like a seesaw. When the filter plates 10 . . . arranged in parallel are closed, the undiluted-liquid supply plate 6 hung on the filter cloth 1 is held between the front and rear filter plates 10, 10, and a filter chamber 15 is formed between the pair of filter cloths 1, 1 hung between filter beds 13, 13 of the filter plates 10. Undiluted liquid is injected under pressure from the liquid supply path 9 of the undiluted-liquid supply plate 6 into the filter chamber 15 with undiluted-liquid supply paths 16 formed in the filter plates 10, 10 communicating with the undiluted-liquid path 8 of the undiluted-liquid supply plate 6, and thereby the undiluted liquid is separated into solid and liquid by the filter cloth 1.

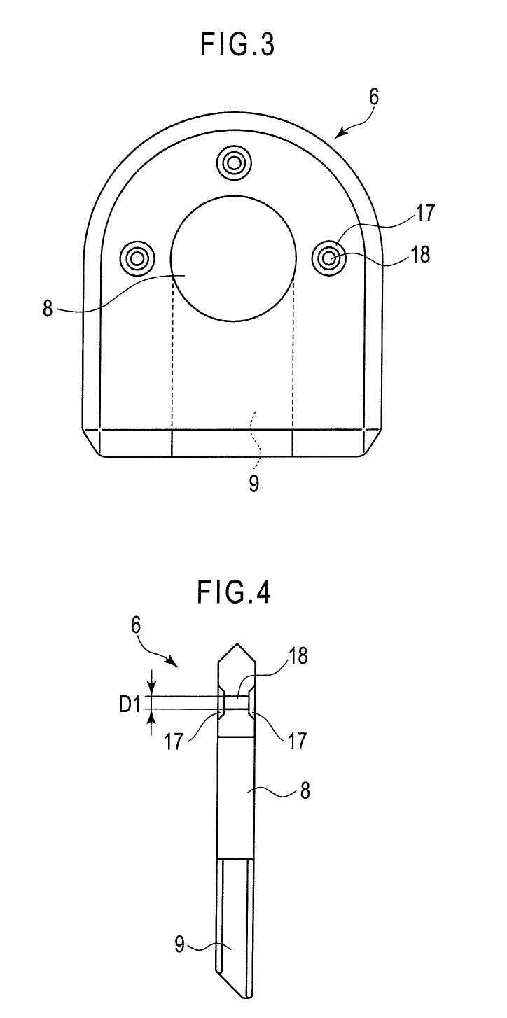

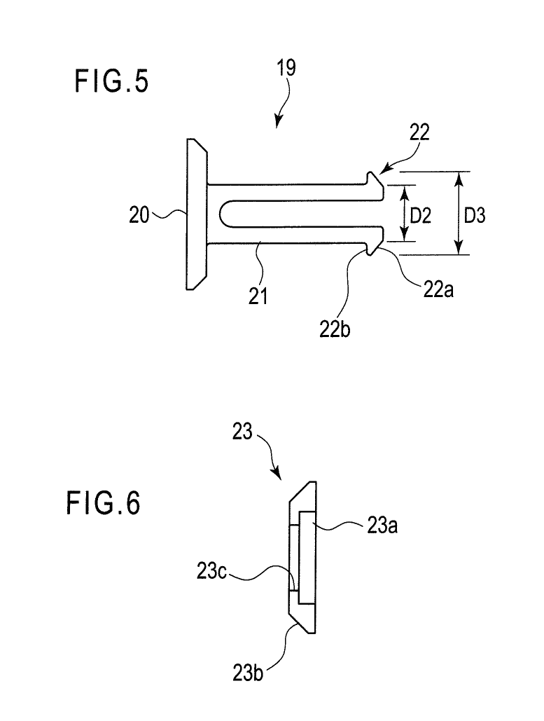

FIG. 3 is a plan view of the undiluted-liquid supply plate 6, and FIG. 4 is a vertical cross-sectional side view of the undiluted-liquid supply plate 6. Multiple through holes (second through holes) 18 . . . are formed in a peripheral portion of the undiluted-liquid path 8 of the undiluted-liquid supply plate 6, the through holes 18 . . . each having inclined concave grooves 17, 17 formed in both surfaces of the undiluted-liquid supply plate 6. FIG. 5 is a side view of a fastener 19 configured to be inserted in each through hole 18 of the undiluted-liquid supply plate 6. The fastener 19 is formed in such a way that multiple flexible elastic legs (elastic deformation portions) 21 . . . are provided perpendicularly to a head flange 20 in the form of a countersunk screw. A locking claw 22 is formed at a tip portion of each elastic leg 21. The locking claw 22 of the fastener 19 is formed by causing the tip of the elastic leg 21 to protrude outward, inclining a front surface portion 22a of the protrusion rearward, and forming a rear surface perpendicularly as a locking portion 22b. A virtual outer diameter D2 between the multiple elastic legs 21 . . . is set slightly smaller than a diameter Dl of the through hole 18 of the undiluted-liquid supply plate 6. In contrast, an outward outer diameter D3 between the multiple elastic legs 21 . . . (an outer diameter between tip portions of the locking portions 22b) is set larger than the diameter D1 of the through hole 18 of the undiluted-liquid supply plate 6. FIG. 6 is a vertical cross-sectional side view of a fastening member 23 configured to engage with the locking claws 22 of the fastener 19. The annular fastening member 23 has a concave groove 23a formed in its front surface, has an inclined surface 23b formed in its rear surface, and has an insertion hole 23c formed at its central portion, the insertion hole 23c having the same diameter as the virtual outer diameter D2 between the elastic legs 21.

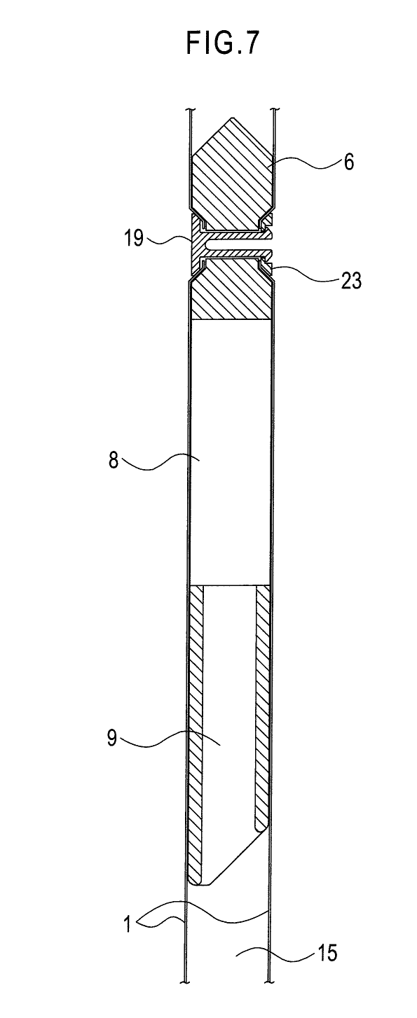

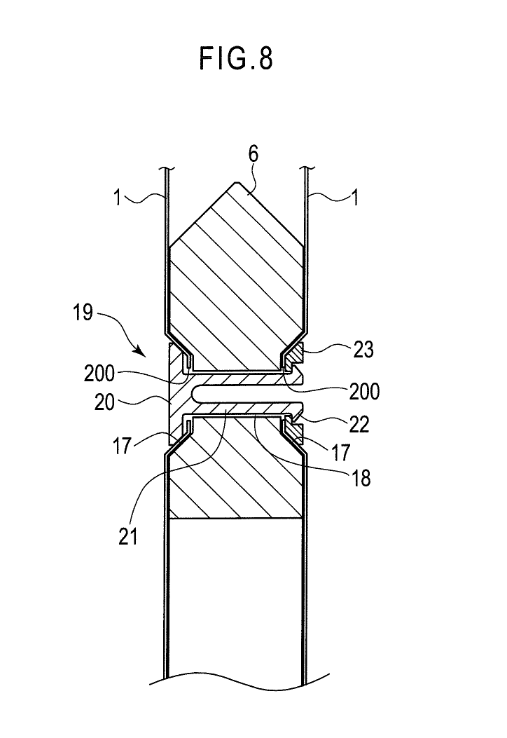

FIG. 7 is a vertical cross-sectional side view of the undiluted-liquid supply plate 6 held between the pair of filter cloths 1, 1. FIG. 8 is an enlarged view of principal part showing how the undiluted-liquid supply plate 6 is fixed to the filter cloths 1, 1 with the fastener 19. The undiluted-liquid supply plate 6 is attached between the filter cloths 1, 1 in the following way. While the undiluted-liquid supply plate 6 is sandwiched between the pair of filter cloths 1, 1, the insertion holes 7, 7 of the filter cloths 1, 1 and the undiluted-liquid path 8 of the undiluted-liquid supply plate 6 are aligned with and caused to communicate with one another, and each through hole 18 of the undiluted-liquid supply plate 6 and corresponding fastening holes (first through holes) 200 of the filter cloths 1, 1 are aligned with and caused to communicate with one another. Then, while the multiple elastic legs 21 . . . are compressed inward, the locking claws 22 provided at the tips of the elastic legs 21 . . . of the fastener 19 are press fitted and inserted into the fastening hole 200 of one of the filter cloths 1, the through hole 18 of the undiluted-liquid supply plate 6, and the fastening hole 200 of the other filter cloth 1. Subsequently, the annular fastening member 23 is attached to the fastener 19 by causing the fastening member 23 to press the inclined front surface portions 22a of the locking claws 22 of the fastener 19 protruding from the concave groove 17 located in the other surface of the undiluted-liquid supply plate 6, and causing the locking portions 22b of the fastener 19 to engage with the concave groove 23a of the fastening member 23. At this time, the other filter cloth 1 is pressed and sandwiched by the inclined surface 23b of the fastening member 23 and the inclined concave groove 17 on the other side of the undiluted-liquid supply plate 6. At the same time, the one filter cloth 1 is pressed and sandwiched by the countersunk-screw-shaped head flange 20 of the fastener 19 and the inclined concave groove 17 on the one side of the undiluted-liquid supply plate 6. In this way, the undiluted-liquid supply plate 6 is closely attached between the filter cloths 1, 1. As described above, since the undiluted-liquid supply plate 6 is closely attached between the filter cloths 1, 1 with the assistance of the head flange 20, the elastic legs 21, and the tip-part locking claws 22 of the fastener 19, the loosening of or falling off of the undiluted-liquid supply plate 6 from the filter cloths 1, 1 never occurs. Each concave groove 17 is formed deeper than the head flange 20, the locking claws 22, and the fastening member 23. Accordingly, the head flange 20, the locking claws 22, and the fastening member 23 never stick out from surfaces of the filter cloths 1 and thus have no possibility of damaging fittings such as the filter cloths 1, the filter plate 10, and gaskets. Since the fastening member 23 is in contact with the concave groove 17 located in the other surface of the undiluted-liquid supply plate 6, the undiluted-liquid supply plate 6 can be brought in close contact with the filter cloths 1, and thus the fastener 19 is never loosened nor allows any gap to let in screen residues or the like. If resin is used as a material of the fastener 19, a highly corrosion-resistant expensive member does not have to be used. Here, the material of the fastener 19 is not limited to resin but may be metal, for example.

### Second Embodiment

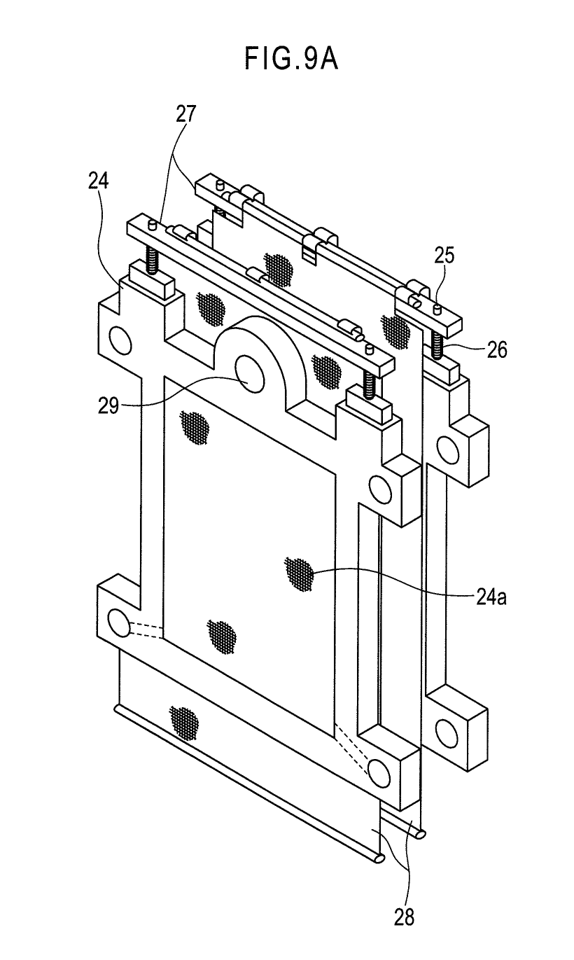

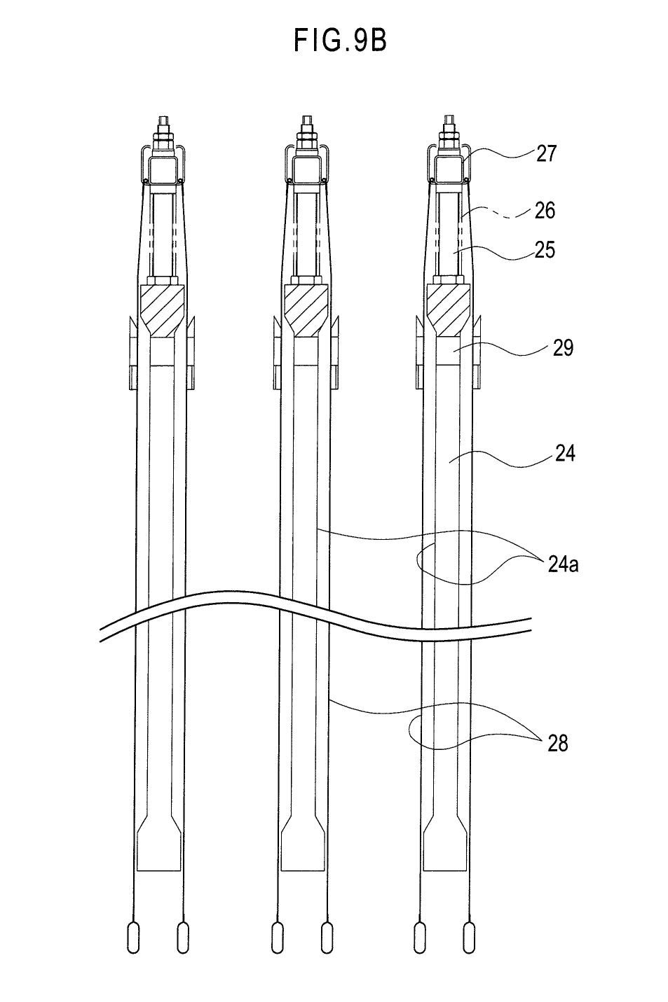

FIG. 9A is a perspective view of a filter press according to a second embodiment and FIG. 9B is a side view of the filter press according to the second embodiment. Filter cloths 28 are hung on front and rear filter plates 24 respectively. A support bar 27 is laid across and supported by support rods 25, 25 which are provided to stand on shoulder portions of filter plates 24 while being inserted into springs 26, 26. Further, the pair of filter cloths 28, 28 are hung along filter beds 24a of the filter plates 24 while upper end portions of the pair of filter cloths 28, 28 are respectively hung from the support bars 27. An undiluted-liquid supply path 29 opens at an upper central portion of each filter plate 24 and is configured to supply undiluted liquid to the filter cloths 28, 28 hung along the filter beds 24a of the filter plates 24.

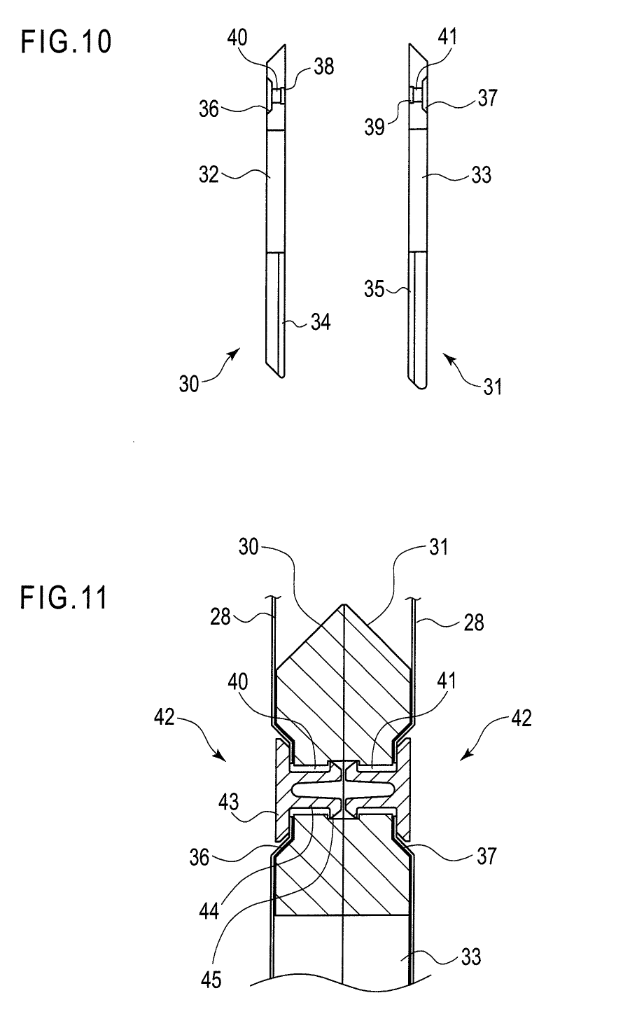

FIG. 10 is a vertical cross-sectional side view of half-divided undiluted-liquid supply plates 30, 31 according to the second embodiment. The half-divided undiluted-liquid supply plates 30, 31 are formed to be approximately bilaterally symmetric, and are fixed to the pair of filter cloths 28, 28 hung along the front and rear filter plates 24, 24 shown in FIG. 9, respectively. The undiluted-liquid supply plates 30, 31 attached together are provided with liquid supply grooves 34, 35 branching from undiluted-liquid paths 32, 33 and configured to supply undiluted liquid to filter surfaces of the filter cloths 28, 28, respectively. Multiple through holes (second through holes) 40 . . . , 41 . . . are provided in peripheral portions of the undiluted-liquid paths 32, 33 of the undiluted-liquid supply plates 30, 31, respectively. Each of the through holes 40 . . . , 41 . . . has an inclined concave groove 36 or 37 in its outer surface and has a concave groove 38 or 39 in the other surface.

FIG. 11 is an enlarged view of principal part of fasteners 42, 42 configured to fix the half-divided undiluted-liquid supply plates 30, 31 to the pair of filter cloths 28, 28, respectively, and hold them between the filter plates 24, 24. The fasteners 42, 42 configured to fix the undiluted-liquid supply plates 30, 31 to the filter cloths 28, 28 have a structure in which multiple flexible elastic legs (elastic deformation portions) 44 . . . are provided perpendicularly to a head flange 43 in the form of a countersunk screw and a locking claw 45 is placed at a tip portion of each elastic leg 44, which is equivalent to a structure of reducing the lengths of the elastic legs 21 of the fastener 19 shown in FIG. 5. The head flanges 43 of the fasteners 42 are brought into pressure contact with the concave grooves 36, 37 of the undiluted-liquid supply plates 30, 31 from above the filter cloths 28, 28, respectively, and the locking claws 45 at the tips of the elastic legs 44 of each fastener 42 are caused to protrude from the through hole 40 (41) of the undiluted-liquid supply plate 30 (31) and to engage with the concave groove 38 (39) in the other surface. In this way, the divided undiluted-liquid supply plates 30, 31 are fixed to the filter cloths 28, 28 hung along the front and rear filter plates 24, 24. When the filter plates 24, 24 are closed, the undiluted-liquid supply paths 29 formed in the filter plates 24 are caused to communicate with the undiluted-liquid paths 32, 33 of the undiluted-liquid supply plates 30, 31, so that undiluted-liquid supply lines are formed in filter surfaces of the filter cloths 28, 28 through the liquid supply grooves 34, of the undiluted-liquid supply plates 30, 31. This embodiment also makes it possible to easily attach the divided undiluted-liquid supply plates 30, 31 respectively to the pair of filter cloths 28, 28 only by pressing the fasteners 42, to prevent the falling off of the undiluted-liquid supply plates even in the repeated filtering operations, and to enable easy attachment or detachment of the undiluted-liquid supply plates in a short period of time. Since the undiluted-liquid supply plates 30, 31 are formed in a half-divided shape, a clogging phenomenon due to fibers and the like can be prevented.

### Third Embodiment

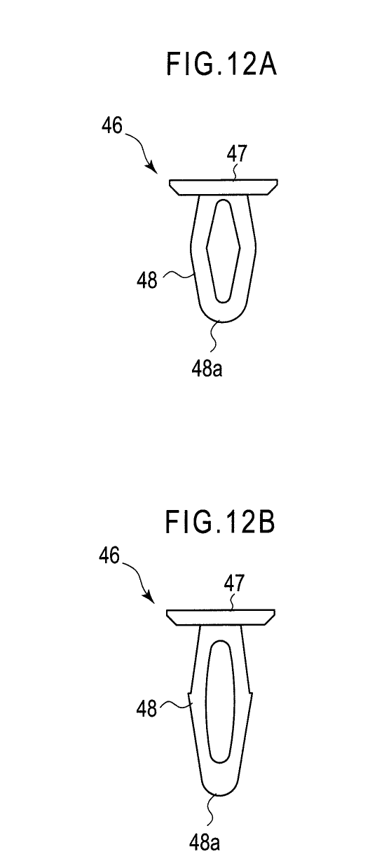

FIGS. 12A and 12B are side views of a fastener 46 according to a third embodiment. The fastener 46 has a structure in which multiple flexible elastic legs (elastic deformation portions) 48 . . . having a coupled tip portions 48a are provided perpendicularly to a head flange 47 in the form of a countersunk screw. The undiluted-liquid supply plate 6 (30 or 31) is fixed to the filter cloth 1 (28) by inserting the tip portions 48a of the elastic legs 48 . . . of the fastener 46 from above the filter cloth 1 (28), and press fitting the elastic legs 48 . . . into the through hole 18 (40 or 41) of the undiluted-liquid supply plate 6 (30 or 31) while extending the tip portions 48a. Since the fastener 46 is brought into pressure contact with the inner surface of the through hole 18 (40 or 41) only by pressing the flexible elastic legs 48 . . . having the coupled tip portions 48a into the through hole, the undiluted-liquid supply plate 6 (30 or 31) can be attached between the filter cloths 1, 1 (28, 28) easily.

### Fourth Embodiment

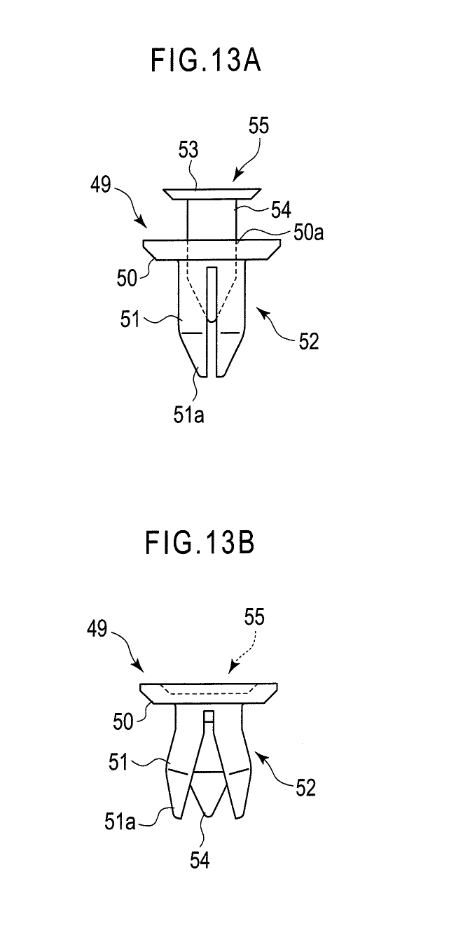

FIGS. 13A and 13B are side views of a fastener 49 according to a fourth embodiment. The fastener 49 is formed of: a female member 52 in which multiple flexible elastic legs (elastic deformation portions) 51 . . . having contracted tip portions 51a are provided perpendicularly to a head flange 50 having an insertion hole 50a; and a male member 55 provided with an insertion shaft 54 on a flange 53. The fastener 49 is configured in such a way that the insertion shaft 54 of the male member 55 is inserted into the insertion hole 50a in the head flange 50 of the female member 52 and that the elastic legs 51 . . . of the female member 52 can be freely expanded and contracted. While the insertion shaft 54 of the male member 55 is moved backward so that the tip portions 51a of the elastic legs 51 . . . of the female member 52 are contracted, the tip portions 51a of the elastic legs 51 . . . are inserted from above the filter cloth 1 (28) and the elastic legs 51 . . . of the female member 52 are inserted into the through hole 18 (40 or 41) of the undiluted-liquid supply plate 6 (30 or 31). Subsequently, the insertion shaft 54 of the male member 55 is moved forward and the flange 53 of the insertion shaft 54 is brought into pressure contact with the head flange 50 of the female member 52 so that the insertion shaft 54 of the male member 55 presses the tip portions 51a of the elastic legs 51 . . . and expands the elastic legs 51 . . . of the female member 52. The elastic legs 51 . . . thus expanded are brought into pressure contact with the inner surface of the through hole 18 (40 or 41) of the undiluted-liquid supply plate 6 (30 or 31), so that the undiluted-liquid supply plate 6 (30 or 31) is fixed to the filter cloth 1 (28). This makes it possible to attach the undiluted-liquid supply plate 6 (30 or 31) between the pair of filter cloths 1, 1 (or 28, 28) only by moving the insertion shaft 54 of the male member 55 forward, and to prevent the falling off of the undiluted-liquid supply plate even in the repeated filtering operations. This also enables easy detachment of the undiluted-liquid supply plate only by moving the insertion shaft 54 of the male member 55 backward.

### Fifth Embodiment

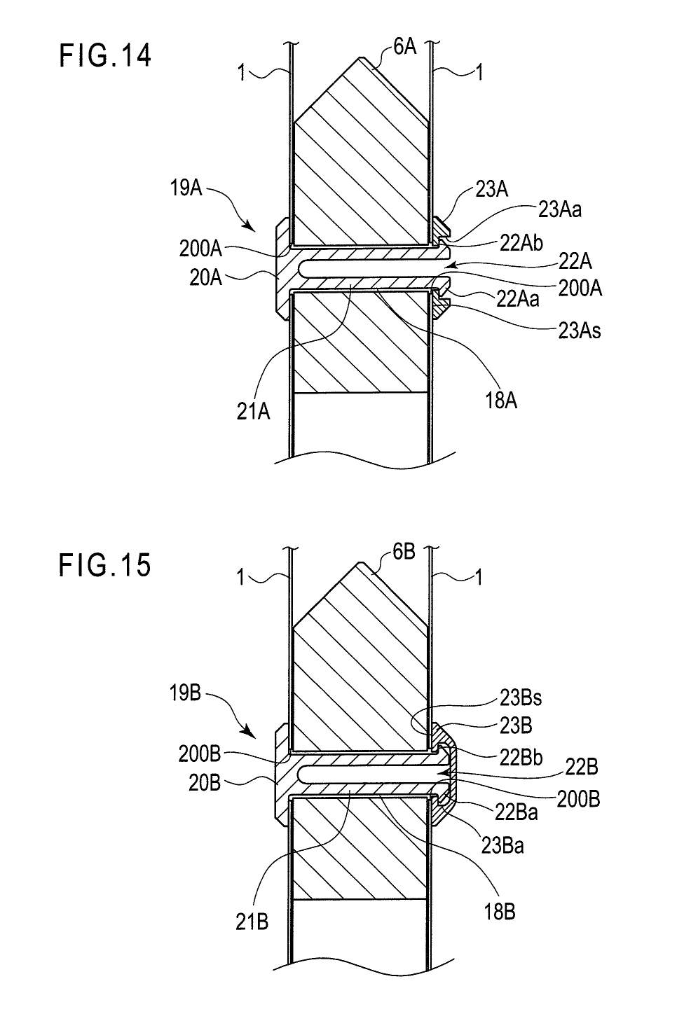

FIG. 14 is an enlarged view of principal part of a device for attaching an undiluted-liquid supply plate 6A to the filter cloths 1, 1 according to a fifth embodiment. The attachment device according to the fifth embodiment is substantially the same as the attachment device according to the first embodiment shown in FIG. 8 except that no concave groove 17 is provided on both sides of the through hole 18 of the undiluted-liquid supply plate 6. In the attachment device according to the fifth embodiment, the undiluted-liquid supply plate 6 is attached between the filter cloths 1, 1 in the following way. While the undiluted-liquid supply plate 6A is sandwiched between the pair of filter cloths 1, 1, the insertion holes 7, 7 of the filter cloths 1, 1 and the undiluted-liquid path 8 of the undiluted-liquid supply plate 6A are aligned with and caused to communicate with one another, and each through hole (second through hole) 18A of the undiluted-liquid supply plate 6A and corresponding fastening holes (first through holes) 200A of the filter cloths 1, 1 are aligned with and caused to communicate with one another. Then, while multiple elastic legs (elastic deformation portions) 21A . . . are compressed inward so that locking claws 22A provided at the tips of the elastic legs 21A . . . of a fastener 19A are press fitted and inserted into the fastening hole 200A of one of the filter cloths 1, the through hole 18A of the undiluted-liquid supply plate 6A, and the fastening hole 200A of the other filter cloth 1. Subsequently, an annular fastening member 23A is attached to the fastener 19A by causing the fastening member 23A to press inclined front surface portions 22Aa of the locking claws 22A of the fastener 19A protruding from the other surface of the undiluted-liquid supply plate 6A, and causing locking portions 22Ab of the fastener 19A to engage with a concave groove 23Aa of the fastening member 23A. At this time, the other filter cloth 1 is pressed and sandwiched by a rear surface 23As of the fastening member 23A and the other surface of the undiluted-liquid supply plate 6A. At the same time, the one filter cloth 1 is pressed and sandwiched by a countersunk-screw-shaped head flange 20A of the fastener 19A and the one surface of the undiluted-liquid supply plate 6A. In this way, the undiluted-liquid supply plate 6A is closely attached between the filter cloths 1, 1. Note that, in this embodiment in which no concave groove is provided in the undiluted-liquid supply plate 6A, concave portions corresponding to the concave grooves may be provided in the filter plate 10 provided to face the head flange 20A and the fastening member 23A. The provision of such concave portions can prevent fittings from being damaged when the filter plates are closed. Embodiments having no concave groove in an undiluted-liquid supply plate to be described later may also have the same configuration.

### Sixth Embodiment

FIG. 15 is an enlarged view of principal part of a device for attaching an undiluted-liquid supply plate 6B to the filter cloths 1, 1 according to a sixth embodiment. The attachment device according to the sixth embodiment is substantially the same as the attachment device according to the fifth embodiment shown in FIG. 14 except that a lid is provided to cover the concave groove 23Aa of the fastening member 23A. In the attachment device according to the sixth embodiment, the undiluted-liquid supply plate 6B is attached between the filter cloths 1, 1 in the following way. While the undiluted-liquid supply plate 6B is sandwiched between the pair of filter cloths 1, 1, the insertion holes 7, 7 of the filter cloths 1, 1 and the undiluted-liquid path 8 of the undiluted-liquid supply plate 6B are aligned with and caused to communicate with one another, and each through hole (second through hole) 18B of the undiluted-liquid supply plate 6B and corresponding fastening holes (first through holes) 200B of the filter cloths 1, 1 are aligned with and caused to communicate with one another. Then, while multiple elastic legs (elastic deformation portions) 21B . . . are compressed inward, locking claws 22B provided at the tips of the elastic legs 21B . . . of a fastener 19B are press fitted and inserted into the fastening hole 200B of one of the filter cloths 1, the through hole 18B of the undiluted-liquid supply plate 6B, and the fastening hole 200B of the other filter cloth 1. Subsequently, an annular fastening member 23B having the lid is attached to the fastener 19B by causing the fastening member 23B to press inclined front surface portions 22Ba of the locking claws 22B of the fastener 19B protruding from the other surface of the undiluted-liquid supply plate 6B, and causing locking portions 22Bb of the fastener 19B to engage with a concave groove 23Ba of the fastening member 23B. At this time, the other filter cloth 1 is pressed and sandwiched by a rear surface 23Bs of the fastening member 23B and the other surface of the undiluted-liquid supply plate 6B. At the same time, the one filter cloth 1 is pressed and sandwiched by a countersunk-screw-shaped head flange 20B of the fastener 19B and the one surface of the undiluted-liquid supply plate 6B. In this way, the undiluted-liquid supply plate 6B is closely attached between the filter cloths 1, 1.

### Seventh Embodiment

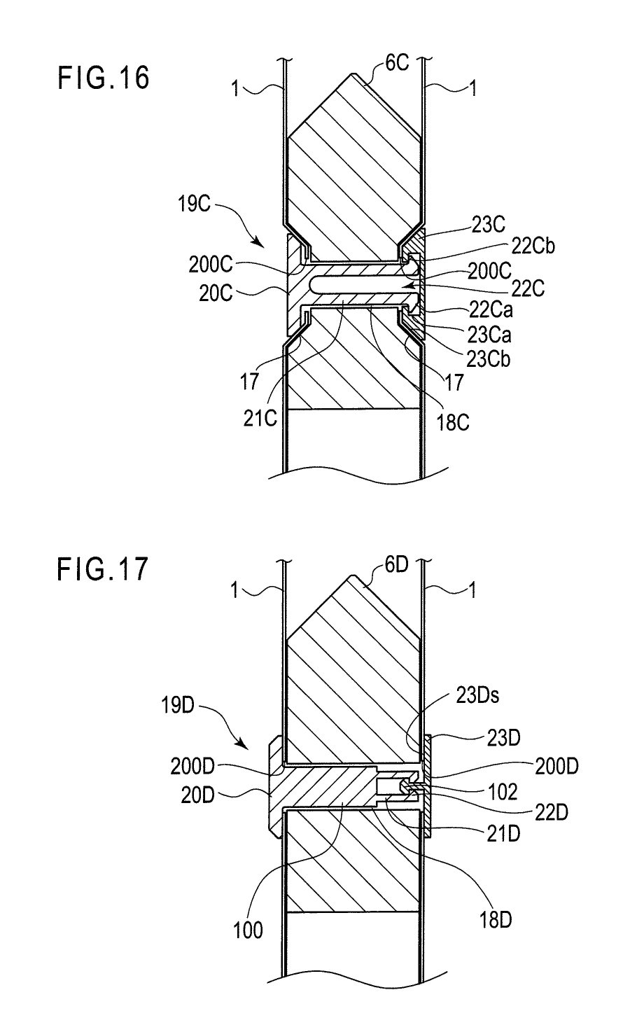

FIG. 16 is an enlarged view of principal part of a device for attaching an undiluted-liquid supply plate 6C to the filter cloths 1, 1 according to a seventh embodiment. The attachment device according to the seventh embodiment is substantially the same as the attachment device according to the sixth embodiment shown in FIG. 15 except that the concave grooves 17 are provided on both sides of the through hole 18B of the undiluted-liquid supply plate 6B. In the attachment device according to the seventh embodiment, the undiluted-liquid supply plate 6C is attached between the filter cloths 1, 1 in the following way. While the undiluted-liquid supply plate 6C is sandwiched between the pair of filter cloths 1, 1, the insertion holes 7, 7 of the filter cloths 1, 1 and the undiluted-liquid path 8 of the undiluted-liquid supply plate 6C are aligned with and caused to communicate with one another, and each through hole (second through hole) 18C of the undiluted-liquid supply plate 6C and corresponding fastening holes (first through holes) 200C of the filter cloths 1, 1 are aligned with and caused to communicate with one another. Then, while multiple elastic legs (elastic deformation portions) 21C . . . are compressed inward, locking claws 22C provided at the tips of the elastic legs 21C . . . of a fastener 19C are press fitted and inserted into the fastening hole 200C of one of the filter cloths 1, the through hole 18C of the undiluted-liquid supply plate 6C, and the fastening hole 200C of the other filter cloth 1. Subsequently, an annular fastening member 23C having a lid is attached to the fastener 19C by causing the fastening member 23C to press inclined front surface portions 22Ca of the locking claws 22C of the fastener 19C protruding from the other surface of the undiluted-liquid supply plate 6C, and causing locking portions 22Cb of the fastener 19C to engage with a concave groove 23Ca of the fastening member 23C. At this time, the other filter cloth 1 is pressed and sandwiched by an inclined surface 23Cb of the fastening member 23C and the inclined concave groove 17 on the other side of the undiluted-liquid supply plate 6C. At the same time, the one filter cloth 1 is pressed and sandwiched by a countersunk-screw-shaped head flange 20C of the fastener 19C and the inclined concave groove 17 on the one side of the undiluted-liquid supply plate 6C. In this way, the undiluted-liquid supply plate 6C is closely attached between the filter cloths 1, 1. Note that the fastening member 23C does not necessarily have to have the lid.

### Eighth Embodiment

FIG. 17 is an enlarged view of principal part of a device for attaching an undiluted-liquid supply plate 6D to the filter cloths 1, 1 according to an eighth embodiment. The attachment device according to the eighth embodiment is substantially the same as the attachment device according to the first embodiment shown in FIG. 8 except that no concave groove 17 is provided on both sides of the through hole 18 of the undiluted-liquid supply plate 6 and that the fastening member 23 is formed of a flat plate and a locking protrusion. In the attachment device according to the eighth embodiment, the undiluted-liquid supply plate 6D is attached between the filter cloths 1, 1 in the following way. While the undiluted-liquid supply plate 6D is sandwiched between the pair of filter cloths 1, 1, the insertion holes 7, 7 of the filter cloths 1, 1 and the undiluted-liquid path 8 of the undiluted-liquid supply plate 6D are aligned with and caused to communicate with one another, and each through hole (second through hole) 18D of the undiluted-liquid supply plate 6D and corresponding fastening holes (first through holes) 200D of the filter cloths 1, 1 are aligned with and caused to communicate with one another. Then, locking claws 22D provided at the tips of elastic legs (elastic deformation portions) 21D . . . extending from a base portion 100 of a fastener 19D are press fitted into the fastening hole 200D of one of the filter cloths 1 and the through hole 18D of the undiluted-liquid supply plate 6D. Subsequently, a flat plate-shaped annular fastening member 23D is attached to the fastener 19D by inserting the fastening member 23D into the through hole 18D from the other surface of the undiluted-liquid supply plate 6D, and causing a locking portion 102 of the fastening member 23D to engage with the locking claws 22D of the fastener 19D inside the through hole 18D while expanding the multiple elastic legs 21D . . . of the fastener 19D outward. At this time, the other filter cloth 1 is pressed and sandwiched by a rear surface 23Ds of the fastening member 23D and the other surface of the undiluted-liquid supply plate 6D. At the same time, the one filter cloth 1 is pressed and sandwiched by a countersunk-screw-shaped head flange 20D of the fastener 19D and the one surface of the undiluted-liquid supply plate 6D. In this way, the undiluted-liquid supply plate 6D is closely attached between the filter cloths 1, 1. Note that the elastic legs 21D are spaced from the inner peripheral surface of the through hole 18D by such a distance that the elastic legs 21D can be elastically deformed and locked to the locking portion 102 of the fastening member 23D.

### Ninth Embodiment

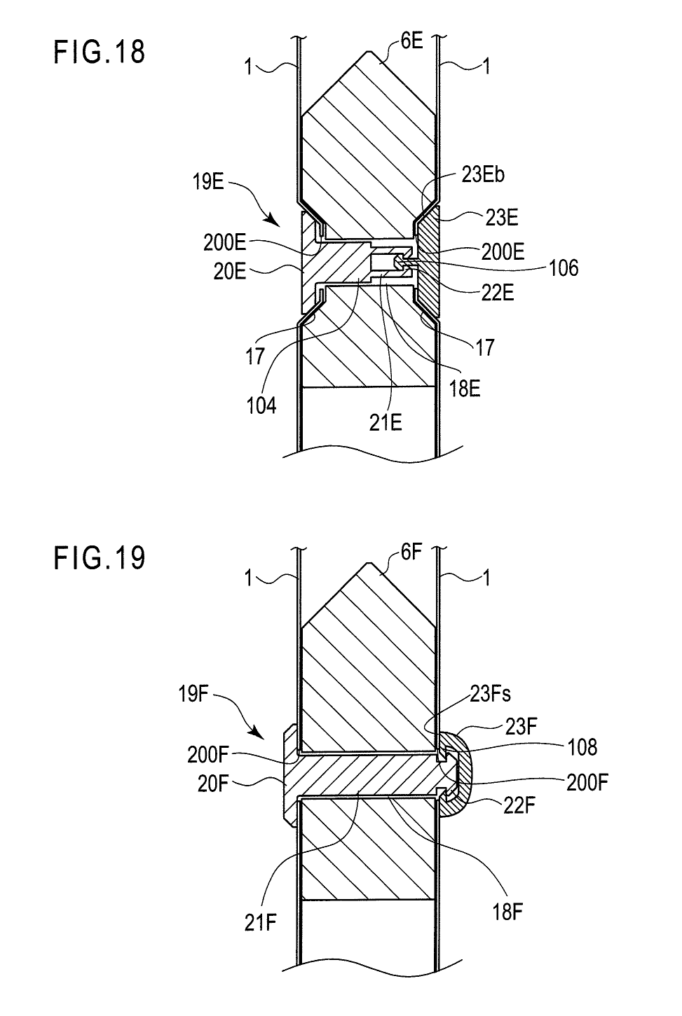

FIG. 18 is an enlarged view of principal part of a device for attaching an undiluted-liquid supply plate 6E to the filter cloths 1, 1 according to a ninth embodiment. The attachment device according to the ninth embodiment is substantially the same as the attachment device according to the eighth embodiment shown in FIG. 17 except that the concave grooves 17 are provided on both sides of the through hole 18D of the undiluted-liquid supply plate 6D. In the attachment device according to the ninth embodiment, the undiluted-liquid supply plate 6E is attached between the filter cloths 1, 1 in the following way. While the undiluted-liquid supply plate 6E is sandwiched between the pair of filter cloths 1, 1, the insertion holes 7, 7 of the filter cloths 1, 1 and the undiluted-liquid path 8 of the undiluted-liquid supply plate GE are aligned with and caused to communicate with one another, and each through hole (second through hole) 18E of the undiluted-liquid supply plate 6E and corresponding fastening holes (first through holes) 200E of the filter cloths 1, 1 are aligned with and caused to communicate with one another. Then, locking claws 22E provided at the tips of elastic legs (elastic deformation portions) 21E . . . extending from a base portion 104 of a fastener 19E are press fitted into the fastening hole 200E of one of the filter cloths 1 and the through hole 18E of the undiluted-liquid supply plate 6E. Subsequently, an annular fastening member 23E is attached to the fastener 19E by inserting the fastening member 23E into the through hole 18E from the other surface of the undiluted-liquid supply plate 6E, and causing a locking portion 106 of the fastening member 23E to engage with the locking claws 22E of the fastener 19E inside the through hole 18E while expanding the multiple elastic legs 21E . . . of the fastener 19E outward. At this time, the other filter cloth 1 is pressed and sandwiched by an inclined surface 23Eb of the fastening member 23E and the inclined concave groove 17 on the other side of the undiluted-liquid supply plate 6E. At the same time, the one filter cloth 1 is pressed and sandwiched by a countersunk-screw-shaped head flange 20E of the fastener 19E and the inclined concave surface 17 on the one side of the undiluted-liquid supply plate 6E. In this way, the undiluted-liquid supply plate 6E is closely attached between the filter cloths 1, 1. Note that the elastic legs 21E are spaced from the inner peripheral surface of the through hole 18E by such a distance that the elastic legs 21E can be elastically deformed and locked to the locking portion 106 of the fastening member 23E.

### Tenth Embodiment

FIG. 19 is an enlarged view of principal part of a device for attaching an undiluted-liquid supply plate 6F to the filter cloths 1, 1 according to a tenth embodiment. The attachment device according to the tenth embodiment is substantially the same as the attachment device according to the first embodiment shown in FIG. 8 except that no concave groove 17 is provided on both sides of the through hole 18 of the undiluted-liquid supply plate 6 and that the elastic deformation function is not provided to the fastener 19 but to the fastening member 23. In the attachment device according to the tenth embodiment, the undiluted-liquid supply plate 6F is attached between the filter cloths 1, 1 in the following way. While the undiluted-liquid supply plate 6F is sandwiched between the pair of filter cloths 1, 1, the insertion holes 7, 7 of the filter cloths 1, 1 and the undiluted-liquid path 8 of the undiluted-liquid supply plate 6F are aligned with and caused to communicate with one another, and each through hole (second through hole) 18F of the undiluted-liquid supply plate 6F and corresponding fastening holes (first through holes) 200F of the filter cloths 1, 1 are aligned with and caused to communicate with one another. Then, a base portion 21F of a fastener 19F is inserted into the fastening hole 200F of one of the filter cloths 1, the through hole 18F of the undiluted-liquid supply plate 6F, and the fastening hole 200F of the other filter cloth 1. Subsequently, an elastically-deformable annular fastening member 23F having a lid is attached to the fastener 19F by pressing the fastening member 23F against a locking claw 22F provided at the tip of the base portion 21F of the fastener 19F protruding from the other surface of the undiluted-liquid supply plate 6F while expanding its locking protrusion (elastic deformation portion) 108 outward, and thereby causing the fastening member 23F to engage with the locking claw 22F. At this time, the other filter cloth 1 is pressed and sandwiched by a rear surface 23Fs of the fastening member 23F and the other surface of the undiluted-liquid supply plate 6F. At the same time, the one filter cloth 1 is pressed and sandwiched by a countersunk-screw-shaped head flange 20F of the fastener 19F and the one surface of the undiluted-liquid supply plate 6F. In this way, the undiluted-liquid supply plate 6F is closely attached between the filter cloths 1, 1. In the case of this embodiment, the diameter of the locking claw 22F of the fastener 19F is set smaller than the diameter Dl of the through hole 18F since the locking claw 22F is not configured to be elastically deformed in such a manner to be fitted in the through hole 18F of the undiluted-liquid supply plate 6F.

### Eleventh Embodiment

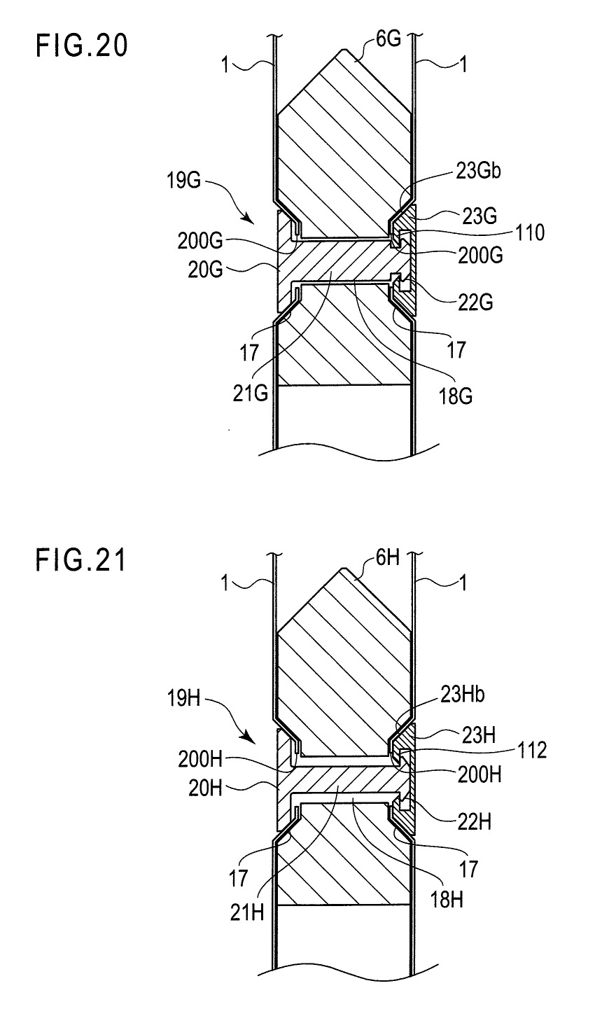

FIG. 20 is an enlarged view of principal part of a device for attaching an undiluted-liquid supply plate 6G to the filter cloths 1, 1 according to an eleventh embodiment. The attachment device according to the eleventh embodiment is substantially the same as the attachment device according to the tenth embodiment shown in FIG. 19 except that the concave grooves 17 are provided on both sides of the through hole 18F of the undiluted-liquid supply plate 6F. In the attachment device according to the eleventh embodiment, the undiluted-liquid supply plate 6G is attached between the filter cloths 1, 1 in the following way. While the undiluted-liquid supply plate 6G is sandwiched between the pair of filter cloths 1, 1, the insertion holes 7, 7 of the filter cloths 1, 1 and the undiluted-liquid path 8 of the undiluted-liquid supply plate 6G are aligned with and caused to communicate with one another, and each through hole (second through hole) 18G of the undiluted-liquid supply plate 6G and corresponding fastening holes (first through holes) 200G of the filter cloths 1, 1 are aligned with and caused to communicate with one another. Then, a base portion 21G of a fastener 19G is inserted into the fastening hole 200G of one of the filter cloths 1, the through hole 18G of the undiluted-liquid supply plate 6G, and the fastening hole 200G of the other filter cloth 1. Subsequently, an elastically-deformable annular fastening member 23G having a lid is attached to the fastener 19G by pressing the fastening member 23G against a locking claw 22G provided at the tip of the base portion 21G of the fastener 19G protruding from the inclined concave groove 17 on the other side of the undiluted-liquid supply plate 6G while expanding its locking protrusion (elastic deformation portion) 110 outward, and thereby causing the fastening member 23G to engage with the locking claw 22G. At this time, the other filter cloth 1 is pressed and sandwiched by an inclined surface 23Gb of the fastening member 23G and the inclined concave groove 17 on the other side of the undiluted-liquid supply plate 6F. At the same time, the one filter cloth 1 is pressed and sandwiched by a countersunk-screw-shaped head flange 20G of the fastener 19G and the inclined concave groove 17 on the one side of the undiluted-liquid supply plate 6G. In this way, the undiluted-liquid supply plate 6G is closely attached between the filter cloths 1, 1. In the case of this embodiment, the diameter of the locking claw 22G of the fastener 19G is set smaller than the diameter D1 of the through hole 18G since the locking claw 22G is not configured to be elastically deformed in such a manner as to be fitted in the through hole 18G of the undiluted-liquid supply plate 6G. Note that the fastening member 23G does not necessarily have to have the lid.

### Twelfth Embodiment

FIG. 21 is an enlarged view of a device for attaching an undiluted-liquid supply plate 6H to the filter cloths 1, 1 according to a twelfth embodiment. The attachment device according to the twelfth embodiment is substantially the same as the attachment device according to the eleventh embodiment shown in FIG. 20 except that the diameter of the base portion 21G of the fastener 19G is smaller. In the attachment device according to the twelfth embodiment, the undiluted-liquid supply plate 6H is attached between the filter cloths 1, 1 in the following way. While the undiluted-liquid supply plate 6H is sandwiched between the pair of filter cloths 1, 1, the insertion holes 7, 7 of the filter cloths 1, 1 and the undiluted-liquid path 8 of the undiluted-liquid supply plate 6H are aligned with and caused to communicate with one another, and each through hole (second through hole) 18H of the undiluted-liquid supply plate 6H and corresponding fastening holes (first through holes) 200H of the filter cloths 1, 1 are aligned with and caused to communicate with one another. Then, a base portion 21H of a fastener 19H is inserted into the fastening hole 200H of one of the filter cloths 1, the through hole 18H of the undiluted-liquid supply plate 6H, and the fastening hole 200H of the other filter cloth 1. Subsequently, an elastically-deformable annular fastening member 23H having a lid is attached to the fastener 19H by pressing the fastening member 23H against a locking claw 22H provided at the tip of the base portion 21H of the fastener 19H protruding from the inclined concave groove 17 on the other side of the undiluted-liquid supply plate 6H while expanding its locking protrusion (elastic deformation portion) 112 outward, and thereby causing the fastening member 23H to engage with the locking claw 22H. At this time, the other filter cloth 1 is pressed and sandwiched by an inclined surface 23Hb of the fastening member 23H and the inclined concave groove 17 on the other side of the undiluted-liquid supply plate 6H. At the same time, the one filter cloth 1 is pressed and sandwiched by a countersunk-screw-shaped head flange 20H of the fastener 19H and the inclined concave groove 17 on the one side of the undiluted-liquid supply plate 6H. In this way, the undiluted-liquid supply plate 6H is closely attached between the filter cloths 1, 1. In the case of this embodiment, the diameter of the locking claw 22H of the fastener 19H is set smaller than the diameter Dl of the through hole 18H since the locking claw 22H is not configured to be elastically deformed in such a manner as to be fitted in the through hole 18H of the undiluted-liquid supply plate 6H. Further, in this embodiment, the diameter of the base portion 21H of the fastener 19H is set smaller than the diameter of the base portion 21G of the fastener 19G of the eleventh embodiment, and the base portion 21H and the locking claw 22H together form substantially a T-shape. Note that the fastening member 23H does not necessarily have to have the lid.

In each of the devices for attaching the undiluted-liquid supply plate to the filter cloths of the filter press according to the above embodiments, the multiple through holes are drilled in the peripheral portion of the undiluted-liquid path of the undiluted-liquid supply plate, the through holes each having the concave grooves formed in both surfaces of the undiluted-liquid supply plate, and the device uses the fasteners each having the multiple elastic legs provided perpendicularly on the head flange. The undiluted-liquid supply plate can be fixed to the filter cloths only by inserting the elastic legs of the fastener into each through hole of the undiluted-liquid supply plate from above the filter cloths. This facilitates attachment of the undiluted-liquid supply plate, prevents the falling off of the undiluted-liquid supply plate even in the repeated filtering operations, and enables easy attachment and detachment of the filter cloths, which are expendables requiring periodic replacement, in a short period of time. Further, the locking claw(s) provided at the tip portion of the fastener is (are) locked by the concave groove on the other surface of the undiluted-liquid supply plate or engage(s) with the fastening member. Hence, the fastener never sticks out from the surface of the filter cloth and thus has no possibility of damaging the filter plates, diaphragms, gaskets, filter cloths, and the like. Furthermore, the half-divided undiluted-liquid supply plates can also be employed to prevent a clogging phenomenon due to fibers and the like. The present invention is applicable, for example, to a device for attaching an undiluted-liquid supply plate to a filter cloth of a filter press configured to process a large volume of sludge such as water supply sludge, sewage sludge, or industrial drainage sludge, or of a multi-chamber filter press. If resin is used as a material of the fastener, the present invention is also applicable to a filter press for use in corrosion-resistant applications.

Although the embodiments of the present invention have been described above, the present invention is not limited to the above embodiments but various modifications can be made.

1. A device for attaching an undiluted-liquid supply plate to a filter cloth of a filter press, the plate being configured to supply undiluted liquid to a filter chamber formed between filter plates, the device comprising:
a leg to be placed inside a first through hole formed in the filter cloth and inside a second through hole formed in the undiluted-liquid supply plate;
a flange provided at an end portion of the leg and having a diameter larger than diameters of the first through hole and the second through hole; and
an elastic deformation portion configured to be elastically deformed in a radial direction of the second through hole to allow and restrict movement of the leg placed inside the first and second through holes in an axial direction of the second through hole.

2. The device for attaching an undiluted-liquid supply plate to a filter cloth according to claim 1, wherein the flange is configured to press the filter cloth against the undiluted-liquid supply plate with the leg placed inside the first and second through holes and the movement of the leg restricted in the axial direction of the second through hole.

3. The device for attaching an undiluted-liquid supply plate to a filter cloth according to claim 1, wherein the flange is configured to be housed in a concave groove formed on a periphery of an opening of the second through hole of the undiluted-liquid supply plate with the leg placed inside the first and second through holes and the movement of the leg restricted in the axial direction of the second through hole.

4. The device for attaching an undiluted-liquid supply plate to a filter cloth according to claim 1, further comprising a protrusion formed at a tip of the leg,
wherein the protrusion is configured to
protrude in the radial direction of the second through hole with the leg placed inside the second through hole, and
restrict the movement of the leg in the axial direction of the second through hole with the leg placed inside the first and second through holes and the filter cloth pressed by the flange together with the undiluted-liquid supply plate.

5. The device for attaching an undiluted-liquid supply plate to a filter cloth according to claim 4, wherein the protrusion is housed in a concave groove formed on a periphery of an opening of the second through hole of the undiluted-liquid supply plate with the leg placed inside the first and second through holes and the movement of the leg restricted in the axial direction of the second through hole.

6. The device for attaching an undiluted-liquid supply plate to a filter cloth according to claim 4, wherein the elastic deformation portion includes a support portion formed in the leg, having the protrusion at an end portion thereof, and being elastically deformable in the radial direction of the second through hole.

7. The device for attaching an undiluted-liquid supply plate to a filter cloth according to claim 4, further comprising a fastening member attachable to and detachable from the protrusion due to the elastic deformation portion, the fastening member engaged with the protrusion being configured to restrict the movement of the leg in the axial direction of the second through hole together with the flange.

8. The device for attaching an undiluted-liquid supply plate to a filter cloth according to claim 7, wherein
the protrusion is configured to protrude in the radial direction of the second through hole to engage with the fastening member, and
the fastening member
is annular,
has a concave portion provided in a front surface thereof and configured to house the protrusion, and
has an inclined surface provided in a rear surface thereof and corresponding an inclined surface formed in a concave groove formed on a periphery of an opening of the second through hole of the undiluted-liquid supply plate.

9. The device for attaching an undiluted-liquid supply plate to a filter cloth according to claim 7, wherein the elastic deformation portion includes an engagement portion formed in the fastening member, configured to engage with the protrusion, and being elastically deformable in the radial direction of the second through hole.

10. The device for attaching an undiluted-liquid supply plate to a filter cloth according to claim 7, wherein the fastening member engaged with the protrusion is housed in a concave groove formed on a periphery of an opening of the second through hole of the undiluted-liquid supply plate.

11. The device for attaching an undiluted-liquid supply plate to a filter cloth according to claim 7, wherein the fastening member engaged with the protrusion is configured to press the filter cloth against the undiluted-liquid supply plate.

12. The device for attaching an undiluted-liquid supply plate to a filter cloth according to claim 1, wherein
the elastic deformation portion includes a curved portion provided in the leg and configured to be elastically deformed in the radial direction of the second through hole to come into pressure contact with an inner surface of the second through hole, and
the curved portion is configured to restrict the movement of the leg in the axial direction of the second through hole with the leg placed inside the first and second through holes and the filter cloth pressed by the flange together with the undiluted-liquid supply plate.

13. A filter press comprising:
filter plates;
a filter cloth placed between the filter plates;
an undiluted-liquid supply plate configured to supply undiluted liquid to a filter chamber formed between the filter plates; and
a device for attaching the undiluted-liquid supply plate to the filter cloth, the device comprising:
a leg to be placed inside a first through hole formed in the filter cloth and inside a second through hole formed in the undiluted-liquid supply plate;
a flange provided at an end portion of the leg and having a diameter larger than diameters of the first through hole and the second through hole; and
an elastic deformation portion configured to be elastically deformed in a radial direction of the second through hole to allow and restrict movement of the leg placed inside the first and second through holes in an axial direction of the second through hole.
